(19) United States
(12) Patent Application Publication
(10) Pub. No.: US 2003/0163445 A1
(43) Pub. Date: Aug. 28, 2003

(54) Method and apparatus for high-speed address learning in sorted address tables

(76) Inventors: Alpesh B. Oza, Sunnyvale, CA (US); Miguel A. Guerrero, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/085,593

(22) Filed: Feb. 26, 2002

(51) Int. Cl. G06F 7/00

(52) U.S. Cl. 707/1

(57) ABSTRACT

Described herein is a method and apparatus for high-speed address learning in sorted address tables.

### TECHNICAL FIELD

The present invention generally relates to the field of network switching and specifically to a method and apparatus for high-speed address learning in sorted address tables.

### BACKGROUND

Network devices that direct data in a computer network rely on sorted routing and address tables to send the data to correct destinations. The tables typically link/match an Internet protocol (IP) address or hardware address, such as a media control access (MAC) address, to a port address and/or a destination address. The table entries are sorted in ascending/descending alphanumeric order. But the address tables are increasing in size to match the expanding complexity of the Internet. When such a table is large, the size not only slows down the speed with which a network device can find an address entry in the table (“lookup speed”), but also slows down the speed with which a network device can update the organization of a table so that the table is available for use after making an address insertion or deletion (“learning speed”).

The learning speed of a network device is particularly affected by an increase in the size of its address table because the data structure used in the table has an ascending/descending order for address entries selected to keep memory usage to a minimum. That is, the organization structure is designed to minimize memory usage requirements, not to foster lookup/learning speed. Address management pointers, with high memory overhead, are avoided entirely necessitating the rigid ascending/descending data structure for arranging the address entries (“keys and/or key entries”). Whereas a linked-list data structure allows the insertion of a new key without affecting the other address entries, an ascending/descending sorted table for switches/routers requires a re-sort of every key that is higher (lower) in the order than the inserted key. A complete top to bottom sort of the entire table is needed each time a key is added or deleted in the lowest position in the hierarchy.

Because a key entry insertion may displace all the other key entries in a table, maintaining the order of the table may require a disproportionately large number of reads and writes to memory. That is, because the keys are stored in increasing order, each preexisting key in the table is moved one space (“rippled”) to provide a space for the new key or to close a space for a deleted key. The number of sort operations required for a traditional ripple of the table is proportional to the number of keys. Thus, to keep the table in order requires a great deal of data movement, typically performed by dedicated hardware (“physical sorting”) in application specific integrated circuits (ASICs). The larger the table of keys, the more seriously degraded will be the performance of the network device.

The worst-case scenario for performance degradation is a key insertion into the first location in the table, since every key in the table will need to be shifted at least one space to make room for the new key. Because the shifting of each key requires a read and a write operation to memory, in the worst case, the number of sort operations required to insert one key will be twice the number of keys in the table. Less than worst-case key insertions also require significant rippling of the table. As tables grow larger due to the expanding Internet, this rippling has become a significant obstacle to network device performance.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram of an example network employing one example embodiment of the invention;

FIG. 2 is a graphical representation of an example address table produced by a high-speed learning engine of the invention;

FIG. 3 is a block diagram of an example embodiment of a high-speed learning engine, according to one aspect of the invention;

FIG. 4 is a block diagram of an example entry engine of FIG. 3, according to another aspect of the present invention;

FIG. 5 is a graphical representation of an example address table used with the example entry engine of FIG. 4, according to another aspect of the invention;

FIG. 6 is a block diagram of the example balancing engine of FIG. 3, according to another aspect of the invention;

FIG. 7 is a graphical representation of an example address table used with the example balancing engine of FIG. 6, according to another aspect of the invention;

FIG. 8 is a flowchart of an example high-speed learning method of the invention;

FIG. 9 is a flowchart of an example method of table management, according to another aspect of the invention;

FIG. 10 is a flowchart of an example table balancing method, according to another aspect of the invention; and

FIG. 11 is a graphic representation of an example storage medium comprising content which, when executed, causes an accessing machine to implement one or more aspects of the high-speed learning engine of the invention.

### DETAILED DESCRIPTION

The present invention is generally directed to a method and apparatus for high-speed address learning in sorted address tables. The invention permits very high-speed address learning, as it reduces the number of sort operations compared with traditional schemes, and frees up memory bandwidth.

In accordance with the teachings of the present invention, a high-speed learning engine (HSLE) is introduced. In one embodiment, the HSLE reduces the number of sorting operations for rippling, accomplishing this task by sectioning a table and buffering the sections (parts) with empty spaces to contain the rippling after a key is inserted, deleted, and/or altered. In this regard, the rippling of a table managed by an HSLE can be contained to the one section of the table in which the key was added or deleted, or can be contained to a few sections. If a section is full and keys need to be rippled into one or more adjacent sections, the rippling only continues until it reaches a section that contains an empty space. Accordingly, the number of sort operations needed to ripple and update a sequentially sorted table has been significantly reduced, increasing the number of address learnings per second for a network device.

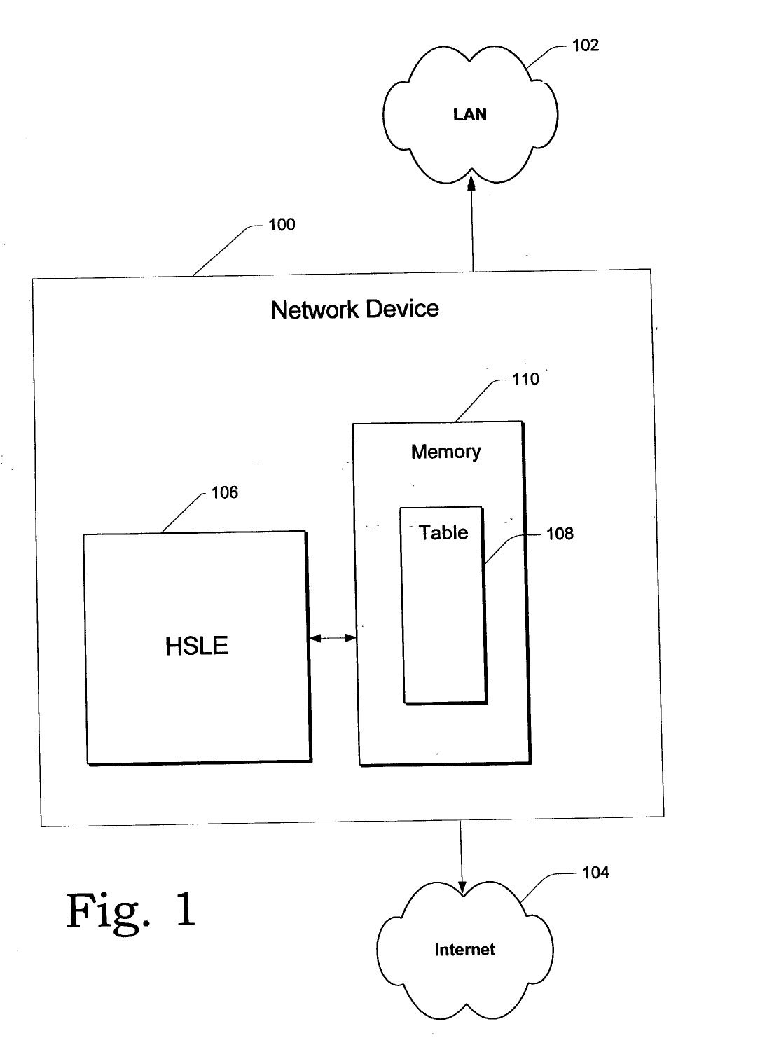

FIG. 1 is a block diagram of an example networking environment in which the invention can be used. A network device 100, is connected to a first network such as a local area network (LAN) 102 and a second network, such as the Internet 104. A network device may be a switch, router, network interface card, managed network interchange, and/or any other device that implements or accesses an address table. In accordance with one example implementation of the invention, network device 100 is depicted comprising an HSLE 106, which may be integrated with other network device 100 components and circuitry or may implemented as a discrete module within the router 100. In other variations, the HSLE 106 may be separate from the network device 100. When the network device 100 receives data packets or datagrams conforming to Internet protocol (IP) from the first network 102, headers on the data packets are read and typically hashed to obtain a destination IP address for forwarding each data packet. The destination IP address must be matched with a port address to the destination network. An address table 108 maintained in a memory 110 contains a data structure that associates the incoming IP address keys with forwarding information (i.e., port information) for each key.

The number of IP addresses needed for a network device 100 to exchange data packets between two or more large networks is theoretically limitless. The capacity of an address table 108 for address key entries, however, is not limitless. If a larger table is used, this requires more powerful (faster, higher capacity, more efficient) hardware and software than traditional hardware and software in order to implement the table. The HSLE 106 speeds up address learning and allows use of a larger table 108 than that used in traditional methods by arranging the table 108 in a manner that reduces the number of memory operations needed.

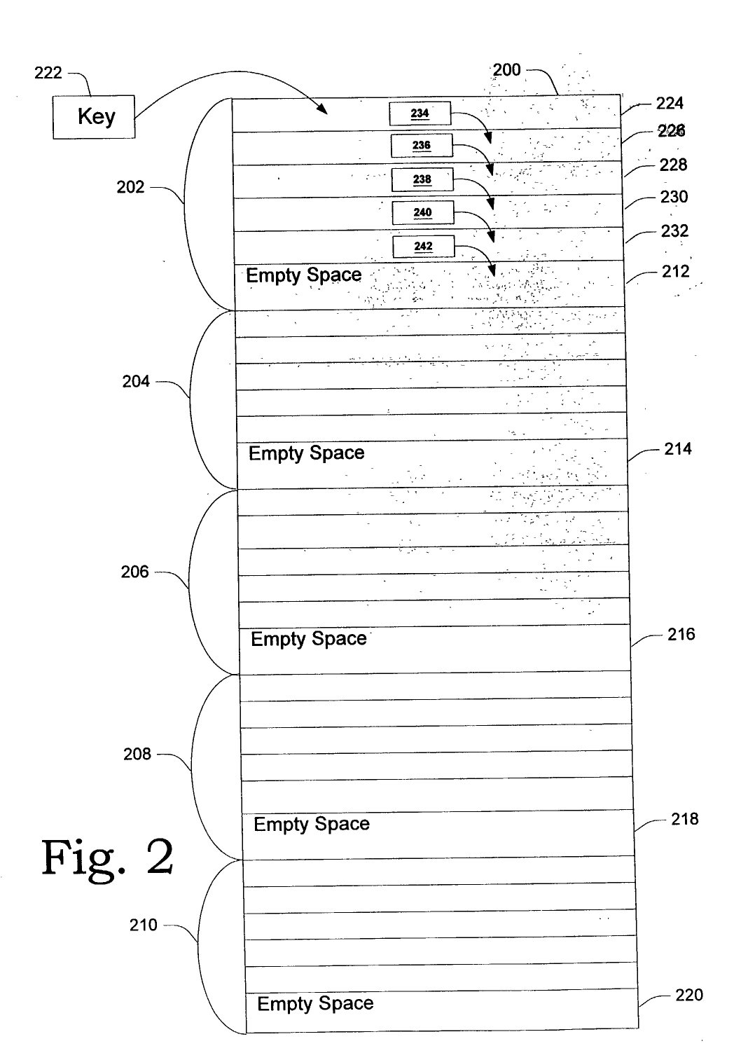

FIG. 2 depicts a graphical representation of an example address table 200 managed by an HSLE 106, according to one embodiment of the invention. The example table 200 has five sections 202-210 of six key entry locations each, for a total of 30 possible key spaces. The example table 200 is only for illustrative purposes, a table for use in the art could have substantially more sections.

Tables implemented and/or managed by the HSLE can be divided into any number of logical sections of fixed size (N). However, the number of logical sections used may be selected to reduce the number of memory accesses required, as will be discussed below. The logical sectioning allows confinement of full rippling to the logical section in which a key change takes place. This confinement of rippling is accomplished by inserting one or more spaces 212-220 in each section. Although the example table 200 is shown with one empty space in each section, multiple spaces may be maintained in each section. An empty space (such as empty space 212), provides spare room so that if a key 222 is inserted in a section 202, the other keys 224-232 in the section 202 may be rippled using the space 212 without requiring all the keys in the entire table 200 to be rippled. If a key is added to a full section, the rippling only continues until it reaches a section with an empty space.

In one embodiment, a logical origin for each section in the table 200 is assigned to the key entry in each section having the lowest numerical value. Logical origin assignments allow lookup of the entries in each section regardless of the position of any empty spaces in a section. This allows keys to be rippled from one section to another to evenly distribute empty spaces, without having to completely rearrange/ripple each section to keep the empty spaces in the same relative position in each section. In other words, having a logical origin for finding the first key in a section allows some sections to have empty spaces at the physical end of a section, while other sections have the empty spaces at the physical beginning of a section. Logical origins used in some embodiments require only a single read and write for each section to reset the section's logical origin during rippling, instead of a read and a write for every key entry in the section, as in traditional schemes.

To illustrate an embodiment of key rippling according to the teachings of the invention, an example key insertion will be explained in detail. Referring to the table 200, a new key 222 is to be inserted in location 224. The other keys in section 202, displaced by the insertion of new key 222, will be rippled into adjacent locations. In one example of a ripple technique, the resorting of keys starts at the empty space 212 of the section 202 and moves in the following chain reaction toward the location of insertion 224. Key 242 is placed into empty space 212 leaving location 232 empty. Key 240 is moved into empty location 232 leaving location 230 empty. Key 238 is moved into empty location 230 leaving location 228 empty. Key 236 is moved into location 228 leaving location 226 empty. Key 234 is moved into location 226 leaving location 224 empty. Location 224 is now empty to receive new key 222. In this rippling technique, the rippling action effectively moves the empty space 212 to the point of key insertion at location 224.

In another ripple technique that uses entry swapping, the action proceeds in the opposite direction of the ripple technique described above. The new key 222 to be inserted is logically swapped with key 234 residing in location 224. Key 234 is swapped with key 236 at location 226. Key 236 is swapped with key 238 at location 228. Key 238 is swapped with key 240 at location 230. Key 240 is swapped with key 242 at location 232. Finally key 242 is moved to empty space 212. In this rippling technique, the keys are effectively moved to the empty space 212 instead of the empty space being moved to the point of insertion, as in the previous example technique. The two rippling technique described are for illustrative purposes. There are many techniques for sorting and/or rippling key entries in a section of a table 200 arranged according to the teachings of the present invention. The invention is usable with any sorting technique for a table arranged in ascending/descending order.

In a traditional address table, the worst-case number of sort operations (Oₘₐₓ) needed to perform learning requires at least one read and one write for all the keys (T) in the table (O_{max(prior art)}=2T). The HSLE substantially reduces the worst-case requirement for sorting operations to that described by equations [1] and [2]:

$$\begin{matrix}{O}_{max ( HSLE )} = 2 \times ( N + S - 1 ) = 2 \times ( N + ( T / N - 1 ) ) & [ 1 ] \\ = 2 \times N + 2 \times ( T / N - 1 ) & [ 2 ]\end{matrix}$$

where,

T is the number of keys in the table;

N is the fixed size of a sector, that is, the number of key entry locations in each section; and

S is the number of sections per table. The number of operations (read/write) needed to shift every key in a section of fixed length N equals 2×N.

In the illustrated example table 200, T equals 30 possible key entry locations, and N equals six key entry locations per section. The term 2×N, therefore, equals twelve operations needed to insert a key entry and ripple the entire section where inserted. The term 2×(T/N−1) is the number of operations required to ripple and/or reset the logical origins of the remainder of the sections in the table, excluding the section already rippled (T/N being the total number of sections). Since the total number of sections T/N is five, equation [2] becomes 2×(6)+2(5−1)=20. O_{max(HSLE)}, the worst-case maximum number of sort operations required for the invention to ripple the table 200 equals twenty (20), compared with the traditional requirement of twice the number of keys in the entire table, or sixty. Thus, in the illustrated example, an HSLE managed table requires only one-third of the sorting operations that would traditionally be required for rippling an address table.

Those skilled in the art will appreciate, given the foregoing introduction, that HSLE performance improves in less than worst-case sorting scenarios. For example, although adding or deleting a key from the first section of a table requires the number of operations described by equations [1] and [2], adding or deleting a key entry from the last section of a table requires only 2×N operations.

The most efficient size N of a section (N denoting the number of key entries the section can contain) reduces the total number of sort operations required. Taking a traditional 16K address table (16384 bytes) as an example, the traditional table would require 2×N, that is, approximately 32K read and write sort operations in a worst-case scenario of inserting a key at the first location in a full table, or approximately 16K sort operations in an average case scenario. Equation [2] is adopted for the worst-case scenario, and can be rearranged into equation [3], where O is the maximum number of operations required for an HSLE to ripple a table in a worst case:

O=2×N+2×T/N−2 [3]

Calculating a derivative of equation [3] and setting the derivative equal to zero to obtain a mathematical minimum yields equation [4]:

$$\frac{\partial O}{\partial O} = 2 - 2 \frac{T}{{N}^{2}} = 0 \to {N}_{improved} = \sqrt{T} \qquad [ 4 ]$$

The improved size of a section N_{improved} in order to reduce the number of sort operations required, from equation [4] is equal to \sqrt{T}, or in this case, \sqrt{16384} =128. Taking a second derivative as shown in equation [5] ascertains a reduced and/or in some cases a minimum number of sort operations achieved by using the optimized section size:

$$\begin{matrix}\frac{{\partial }^{2} O}{\partial {O}^{2}} = 4 \frac{T}{{N}^{3}} > 0 \to min \\ So , & [ 5 ] \\ {O}_{optimal} = 2 \sqrt{T} + 2 ( \frac{T}{\sqrt{T}} - 1 ) = 4 \sqrt{T} - 2 & [ 6 ]\end{matrix}$$

Applying this to a traditional “16K” table with section sizes set to 128 key locations per section following the teachings of the invention, only 4\sqrt{T} −2, or in this case

$$4 \sqrt{16384} - 2 = 510$$

sort operations in the worst-case scenario, (255 sort operations in the average case scenario) would be required, which is approximately 64 times faster than traditional techniques.

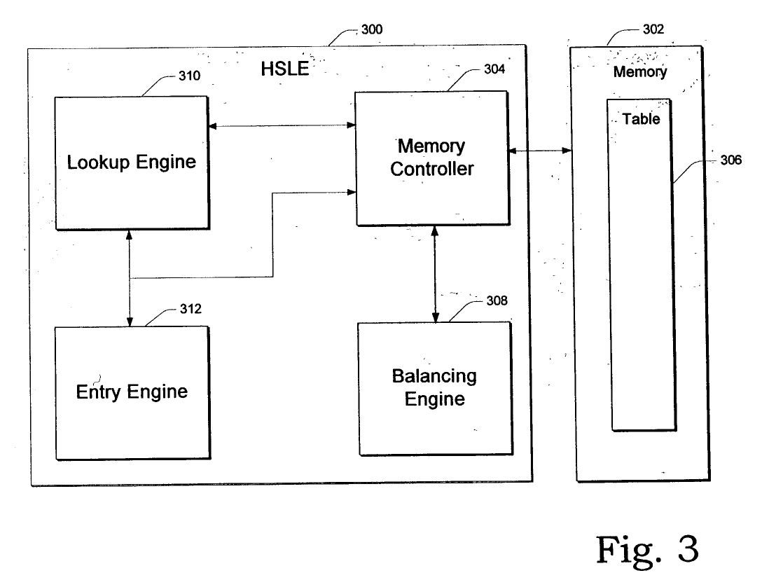

FIG. 3 is block diagram of an example HSLE 300, according to one embodiment of the invention. A memory 302 is serviced by a memory controller 304, which implements read/write operations for maintaining the address table 306 in the memory 302. A balancing engine 308, lookup engine 310, and an entry engine 312 are communicatively coupled as shown.

In this embodiment, the entry engine 312 receives a key to be added or deleted, sending the key to the lookup engine 310. The lookup engine 310 consults the table 306 in the memory 302 and finds the section of the table where the key will be inserted or deleted. The lookup engine 310 may use any hardware and/or software implemented method for the lookup, preferably an accelerated or high-speed lookup method such as a pipelined binary search and/or a discriminant bits search. Once the lookup engine 310 ascertains the section where a key change will take place, it returns a section number to the add-delete-engine 402.

The entry engine 312 receives the section number returned from the lookup engine 310 and reads the entire section corresponding to the section number including any empty key entry spaces. The entry engine 312 then performs a sort of the section following the ordering model of the particular table 306. The entry engine 312 then writes the entire section back into the table 306.

The balancing engine 308 continuously monitors the table 306 and creates one or more empty spaces in each section of the table 306. In variations, the balancing engine 308 may only monitor the table 306 intermittently, or as resources allow. If the total number of keys in the table 306 equals T and the number of empty spaces in each section equals E, then the total memory 302 requirement for setting up the table equals T+SE where S is the total number of sections in the table 306.

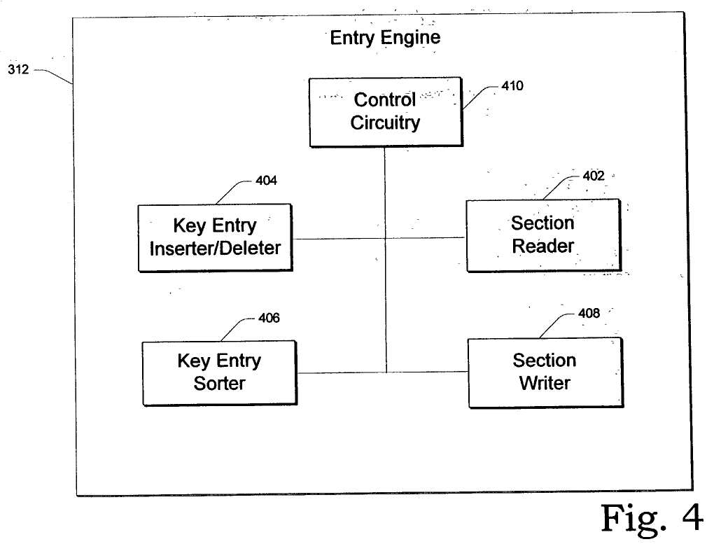

FIG. 4 is a block diagram in greater detail of the example entry engine 312 of FIG. 3. Within the entry engine 312, a section reader 402, key entry inserter/deleter 404, section sorter 406, and section writer 408 are communicatively coupled with control circuitry 410 as depicted. In this embodiment, the entry engine 312 receives a key derived from a data packet or data segment sent to the network device 100 or switch and passes the key to the lookup engine 310, as discussed above. A section number from the lookup engine 310 is received back, allowing the section reader 402 to read the section of the table 306 in which the key change will be made. The key entry inserter/deleter 404 inserts or deletes the key to or from the list of key entries obtained from the section read. The section sorter 406 arranges the entries according to the order maintained in the table 306. The section writer 408 then writes the sorted section back into memory.

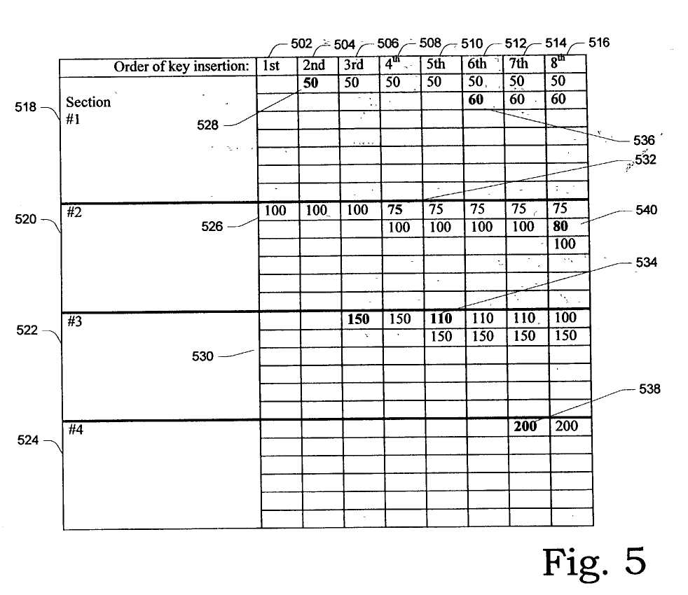

FIG. 5 is a graphical representation of an example address table 500 produced by an example embodiment of the entry engine-engine 312. The table is depicted with four sections 518-524, at eight different times 502-516, illustrating how key entries are added to the table. In this embodiment, to minimize the number of memory access and to work in a complementary manner with embodiments of the balancing engine 308, the entry engine 312 inserts key entries beginning at the middle of the table and working toward the top and bottom of the table 500.

In the initial state 502, an example key entry “100” 526 is inserted at a middle section, namely, section two 520.

The second insertion 504 is key entry “50” 528, which is inserted in section one 518 since 50 is less than the previous key entry “100” 526.

The third insertion 506 is key entry “150” 530, which is inserted in section three 522 since 150 is greater than key entry “100” 526.

The fourth insertion 508 is key entry “75” 532, which may be inserted in either section one 518 or section two 520 since 75 is between key entry “50” 528 and key entry “100” 526, and the keys in the two sections (key entry “50” 528 and key entry “100” 526) are evenly distributed between the two sections. Section two 520 is arbitrarily selected, and key entry “75” 532 is inserted in section two 520 beneath key entry “100” 526.

The fifth insertion 510 is key entry “110” 534, which must be inserted in section three 522 since 110 is between key entry “100” 526 and key entry “150” 530, but section two 520 already has two key entries while section three 522 only has one key entry. Key entry “110” 534 is inserted in section three 522 beneath key entry “150” 530.

The sixth insertion 512 is key entry “60” 536, which must be inserted in section one 518 since 60 is between key entry “50” 528 and key entry “75” 532, but section two 520 already has two key entries while section one 518 only has one key entry. Key entry “60” 536 is inserted in section one 518 above key entry “50” 536.

The seventh insertion 514 is key entry “200” 538, which is inserted in section four 524 since 200 is greater tha key entry “150” 530 in section three 522, and section four has no key entries compared to two key entries in section three 522.

The eighth insertion 516 is key entry “80” 540, which is inserted in section two 520 since 80 is between key entry “75” 526 and key entry “100” 526.

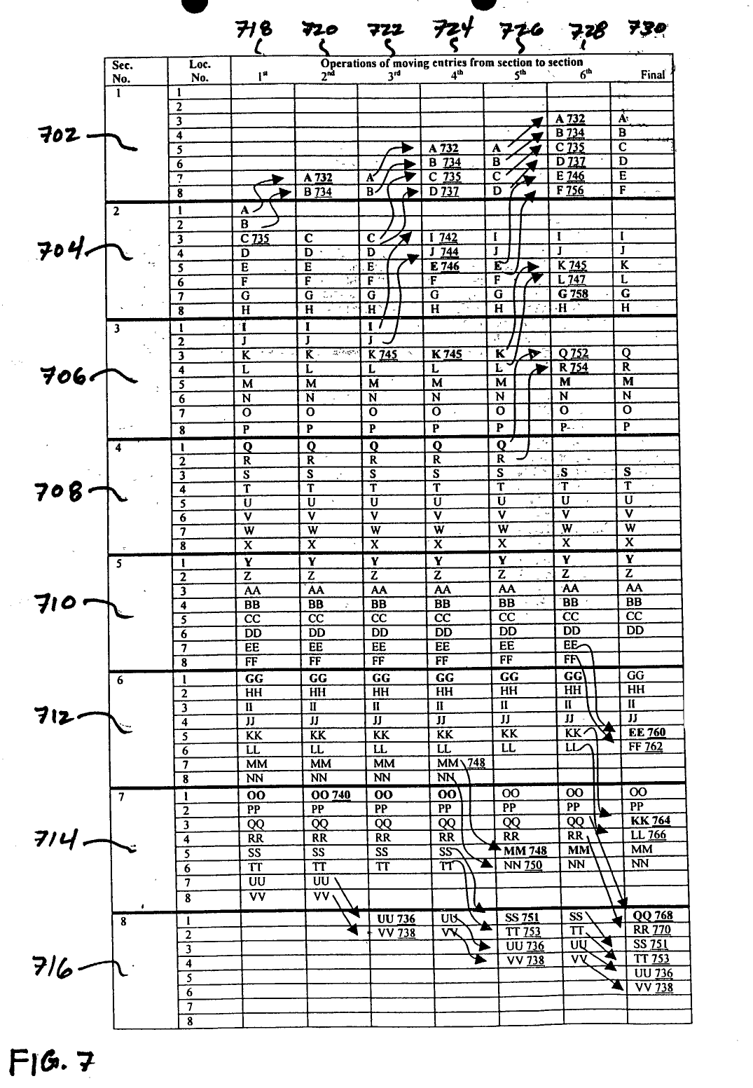

As will be appreciated by the even distribution of key entries in the table 500 and by the descriptions of the balancing engine 308 which will follow (see FIG. 7 and accompanying description), some embodiments of the entry engine 312 and the balancing engine 308 cooperate with each other and share the task of maintaining the even distribution of key entries and empty spaces among the sections of an address table 500.

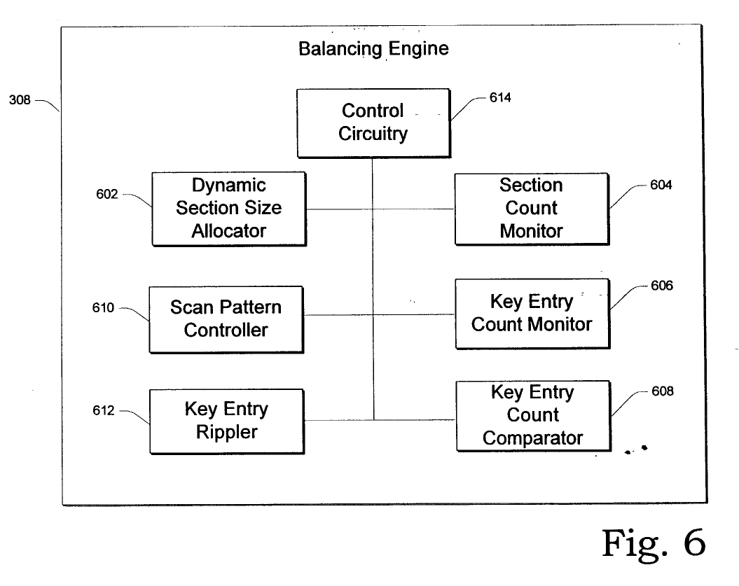

FIG. 6 is a block diagram of the example balancing engine 308 of FIG. 3. In accordance with the illustrated embodiment, balancing engine 308 is depicted comprising a dynamic section size allocator 602, section count monitor 604, key entry count monitor 606, key entry count comparator 608, scan pattern controller 610, and key entry rippler 612 communicatively coupled with control circuitry 614 as depicted. The balancing engine 308 monitors the table 306 and maintains a periodic distribution of empty key entry spaces, that is, maintains one or more empty spaces in each section of the address table.

In one embodiment, the balancing engine 308 continuously runs in the background, or as resources are available, to evenly distribute key entries and empty spaces among the sections of an address table. This may require extra memory and also extra hardware, but the advantage is a significant reduction in sort operations that will be required when adding or deleting a key to or from the address table.

In this embodiment, the dynamic section size allocator 602 determines how many logical sections there will be in the address table based on an actual and/or anticipated total number of entries, using calculations such as those disclosed in the discussion under FIG. 2. In other embodiments, the size of the table and number of logical sections may be fixed, and/or hardwired into the circuitry.

The key entry count monitor 606 continuously monitors the number of valid key entries in each valid section, and the section count monitor 604 continuously monitors the section numbers of the lowest and highest valid sections, that is sections having a valid key entry. Based on the number of valid sections, and the number of valid key entries in each valid section, the balancing engine 308 will move key entries from one section to the an adjacent section to balance the number of key entries in all sections.

A scan pattern controller 610 moves the balancing and/or rippling action of the entry rippler 612 from section to section in a pattern that provides the greatest efficiency. In one embodiment, the scan pattern controller 610 moves from the highest and lowest sections (outside sections) toward the middle. This is to complement an embodiment of the entry engine 312 that places key entries in the middle of the table first. If key entries are preferably places in the middle of the table, then empty spaces are more likely to exist at the beginning and end of the table. Therefore, in this embodiment, the scan pattern controller 610 begins to create spaces for the table by adopting a rippling pattern of moving the outermost (highest and lowest) keys to the outside and working toward the middle, rippling keys into the spaces created as other keys are moved into empty spaces at the top and bottom of the table. This has the effect of moving empty spaces toward full sections closer to the middle of the table where new key entries are being inserted by the aforementioned (see discussion under FIG. 4) embodiment of the entry engine 312. The scan pattern controller 610 moves the balancing action from both ends of the table, converges in the middle section, and starts over at the ends of the table.

FIG. 7 shows a graphical representation of an example address table 700 at seven points in time 718-730, the points in time representing states of the table before, during, or after six iterations of the balancing engine 308. The iterations depict how the balancing engine 308 moves entries from section to section, in accordance with one example implementation of the invention. In this example table 700, the section size equals eight memory spaces (six locations for key entries and two locations for empty spaces), and the number of sections 702-716 equals eight, so that the table supports 48 key entries. This example shows an initial worst-case key entry distribution for rippling by the balancing engine 308.

In the initial state of the table 700, at the beginning of the first iteration 718 of the balancing engine 308, section one 702 and section eight 716 are empty of key entries, while sections two through seven 704-714 are full, having key entries that are sorted in logical order. (The key corresponding to the logical origin of each section is highlighted in bold letters.) The key entry count comparator 608 compares the number of key entries in section one 702 with the number of key entries in section two 704. If the difference in the number of key entries between the two sections is greater than one (in the initial state 718 of this table 700, there is a difference of eight key entries between section two 704 and section one 702), then the key entry rippler 612 moves a number of key entries, in this example the key entries “A” 732 and “B” 734, from section two 704 to section one 702. Before being moved, key entry “A” 732 was the logical origin for section one 702, but since it has been moved out of the section, key entry “C” 735 becomes the new logical origin for section one 704. Section one 704, which initially was full, now has two empty spaces.

At the beginning of the second iteration 720, the scan pattern controller 610 directs the key entry rippler 612 from the top of the table 700 to the bottom of the table 700, where the key entry count comparator 608 compares the number of key entries in section seven 714 with the number of key entries in section eight 716. Because the difference is greater than one, key entries “UU” 736 and “VV” 738 in section seven 714 are moved by the key entry rippler 612 to section eight 716. Key entry “OO” 740 remains the logical origin of section seven 714. Key “UU” 736 becomes the new logical origin of section eight 716. Section seven 714, which was full, now has two empty spaces.

At the beginning of the third iteration 722, the scan pattern controller 610 directs the action of the key entry rippler 612 back to the top of the table 700. The key entry count comparator 608 compares the number of key entries in section three 706 with the number of key entries in section two 704 and since section three 706 has two more key entries than section two 704, key entries “I” 742 and “J” 744 are rippled from section three 706 to section two 704. This leaves key entry “K” 745 as the new logical origin of section three 706. To maintain the desirable empty space in section two 704, key entry “C” 735 and key entry “D” 737 are rippled from section two 704 to section one 702, leaving key entry “E” 746 as the new logical origin of section two 704. In some embodiments, as illustrated, entries “A” and “B” 732, 734 may be moved within section one 702 when entries “C” and “D” 735, 737 are rippled to section one 702.

At the beginning of the fourth iteration 724, the key entry rippler 612 follows the scan pattern back to the bottom half of the table 700. The key entry count comparator 608 compares the number of key entries in section six 712 with the number of key entries in section seven 714. Since section six 712 has two more key entries than section seven 714, key entries “MM” 748 and “NN” 750 are rippled toward the outside (bottom) of the table 700 from section six 712 to section seven 714, displacing key entries “SS” 751 and “TT” 753 from section seven 714 to section eight 716.

At the beginning of the fifth iteration 726, the key entry rippler 612 follows the scan pattern back to the top half of the table 700. The key entry count comparator 608 compares the number of key entries in section four 708 with the number of key entries in section three 704. Since section four 708 has two more key entries than section three 706, key entries “Q” 752 and “R” 754 in section four 708 are rippled to section three 706, displacing entries “K” 745 and “L” 747 from section three 706 to section two 704, which in turn displace entries “E” 746 and “F” 756 from section two 704 to section one 702. Key entry “G” 758 is left as the logical origin of section two 704.

In the sixth iteration 728, the key entry rippler 612 follows the scan pattern back to the bottom half of the table 700. The key entry count comparator 608 compares the number of key entries in section five 710 with the number of key entries in section six 712. Since section five 710 has two more key entries than section six 712, key entries “EE” 760 and “FF” 762 in section five 710 are rippled to section six 712, displacing key entries “KK” 764 and “LL” 766 from section six 712 to section seven 714, which in turn displace key entries “QQ 768 and “RR” 770 from section seven 714 to section eight 716.

The final state of the table 730, after one complete cycle of the balancing engine 308 from the outsides of the table 700 to the middle, results in six key entries and two empty spaces in each of the sections 702-716, an even distribution of the key entries and empty spaces across the table 700. As discussed above, the key entries designated as the logical origin of each section allow the empty spaces in each section to physically reside at various locations within the section, such as the beginning or end of a section. The availability of empty spaces in or near each section afforded by the balancing engine 308 greatly accelerates the performance of the entry engine 312, as only one section typically needs to be rippled for each key entry insertion or deletion.

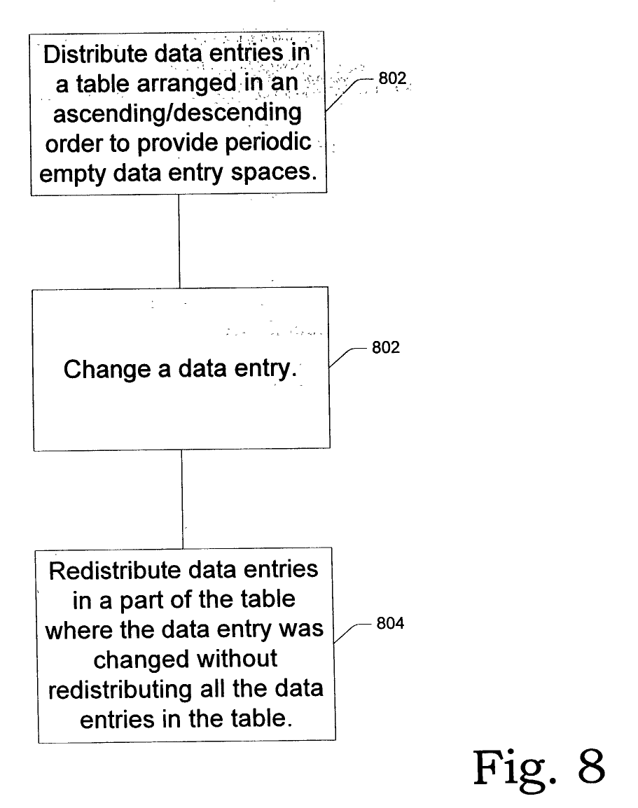

FIG. 8 is a flowchart of an example high-speed learning method of the invention. First, data entries are distributed in a table arranged in an ascending/descending order to provide periodic empty data entry spaces 802. The ascending/descending order of the table dictates that the data entries are in an order, however the order may be logical, and does not have to be physical, that is, the ascending/descending entries do not have to be contiguous in memory, and/or in contiguous memory/table locations. The order may be ascending or descending, and furthermore may be a numerical order and/or a derived numerical order, such as when the letters of an alphabet are assigned a value for alphanumeric sorting purposes. Empty data entry spaces dispersed periodically throughout the table need not affect the logical order of the table. Logical origins may be used to keep track of valid data entries without regard for empty data entry spaces. Thus, a logical origin may be assigned to the first valid data entry in a section of the table, even though the physical section may begin with one or more empty spaces.

The distribution of data entries can include moving data entries between logical sections of the table to maintain both a substantially even distribution of the data entries and a substantially even distribution of the empty data entry spaces in each of the logical sections of the table. The distribution of data entries may be performed at time intervals or may be performed continuously.

A data entry is then changed 804. “Changing” a data entry includes any insertion, deletion, and/or alteration of a data entry. The mere alteration of a data entry is included in the method, because editing a value in memory may require some embodiments of the invention to double-check the section of the table in which the changed data entry resides by reading and writing to memory, and such reading and writing to memory may be regarded by some persons skilled in the art as distributing data entries.

Finally, the method includes redistributing data entries in a part of the table where the data entry was changed to maintain the order without redistributing all the data entries in the table 806. In accordance with one aspect of the invention, limiting the redistribution of data entries (sorting and/or rippling) to one section of the table accelerates the learning of new data entries in table sorted in ascending/descending order.

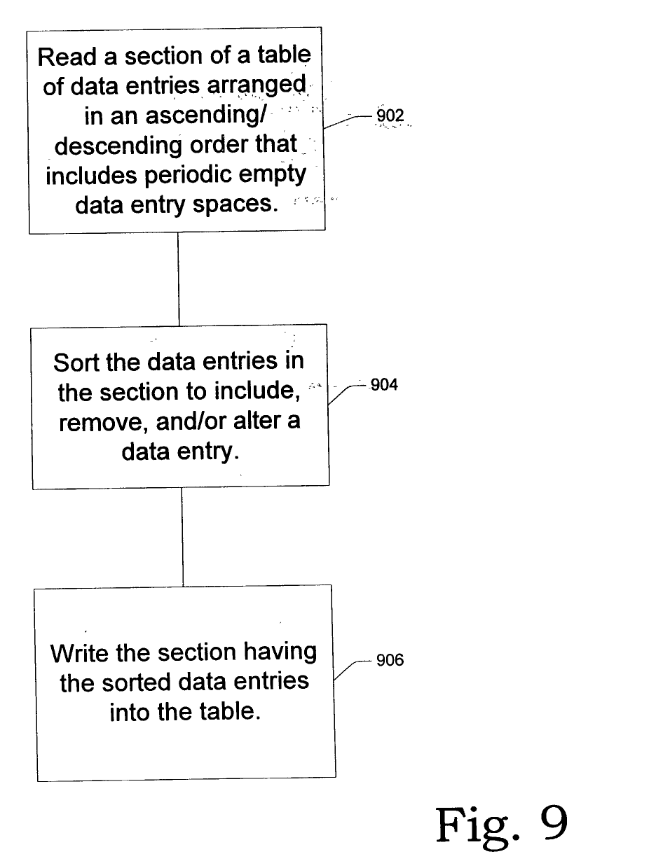

FIG. 9 is a flowchart of an example method for adding and deleting data entries, according to one aspect of the invention. A section of a table of data entries arranged in an order that includes periodic empty data entry spaces is read 902. The empty data entry spaces do not need to be distributed in a perfect periodicity. In fact, the relative position of empty spaces in various sections of a table may vary, and the ascending/descending order of valid data entries may be tracked and may appear logically seamless by using logical origin values to track some or all of the data entries. The data entries in the section are sorted in order to include, remove, and/or alter a data entry 904. The section having the sorted data entries is written into the table 906.

The illustrated example method may be performed by using an entry engine 400 to perform all or part of the method. The entry engine 400 may divide the method up between various components, routines, objects, and/or circuits. For example, the entry engine 400 may have a section reader 402, a section writer 408, a data entry inserter/deleter 404, and a data entry sorter 406. The entry engine 400, however, could have additional or different components that substantially perform the method.

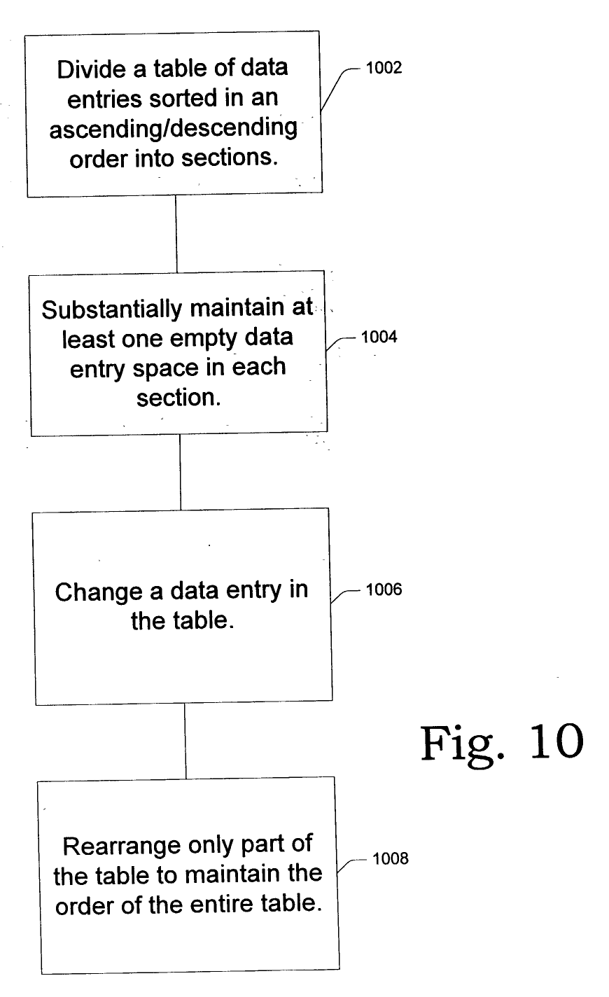

FIG. 10 is a flowchart of an example table balancing method, according to one aspect of the invention. A table of ascending/descending ordered data entries is divided into sections 1002. The sections could be physical sections, but may also be logical sections. At least one empty data entry space is substantially maintained in each section 1004. The presence of empty data entry spaces interspersed with the data entries does not negate the ascending/descending order of the table. Logical origins may be assigned to some or all of the data entries so that the ascending/descending order appears seamless without regard for any empty data entry spaces. Sometimes a section becomes full when a data entry is inserted. The lack of an empty data entry space in a section does not negate the method, but is rather one component of “maintaining” an empty data space. In other words, a full section is a table condition that the method seeks to remedy.

A data entry in the table is changed 1006. The change may be a data entry insertion, deletion, and/or alteration. Only part of the table is rearranged to maintain the order 1008. Since only part of the table needs to be rearranged after a data entry change, learning a new data entry list is accelerated.

A balancing engine 600 may be used to perform the method. The balancing engine 600 may divide the method up between various components, routines, objects, and/or circuits. For example, the balancing engine may have a a dynamic section size allocator 602, a section count monitor 604, a key entry count monitor 606, a key entry count comparator 608, a scan pattern controller 610, and a key entry rippler 612, which may be communicatively coupled with control circuitry 614. The balancing engine 600, however, could have additional or different components that substantially perform the method.

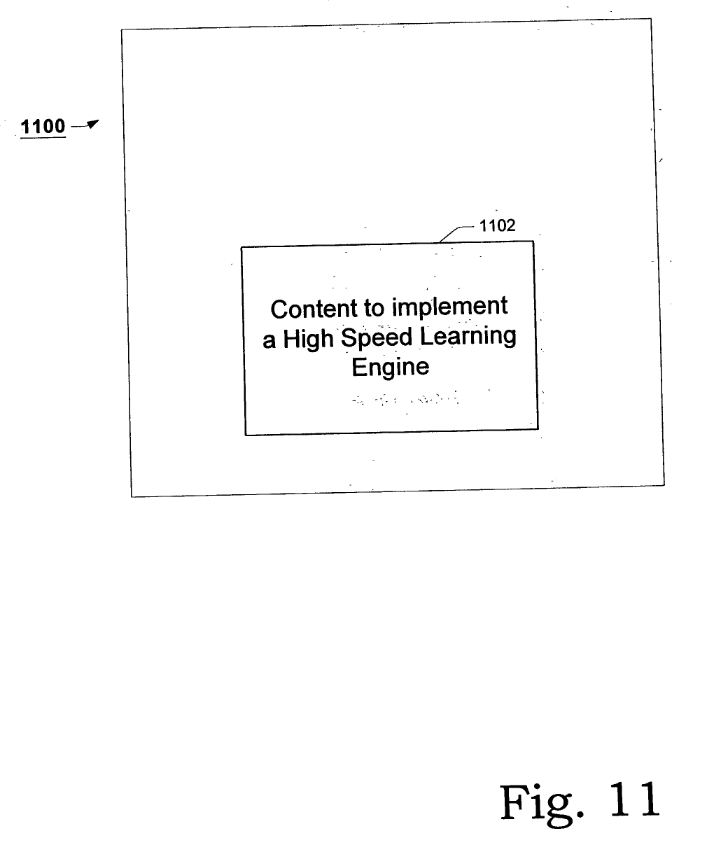

FIG. 11 is a graphical representation of an article of manufacture comprising a machine-readable medium 1100 having content 1102, that causes a host device to implement one or more aspects of a high-speed learning engine and/or method of the invention. The content may be instructions, such as computer instructions, or may be design information allowing implementation. The content causes a machine to implement the method and/or apparatus, including distributing data entries in a table arranged in an order to provide periodic empty data entry spaces, changing a data entry, and distributing data entries in a part of the table where the data entry was changed to maintain the order without redistributing all the data entries in the table. The table can be an address table used by a network device, but may be any table where data entries are sorted in ascending/descending order.

The methods and apparatuses of the invention may be provided partially as a computer program product that may include the machine-readable medium. The machine-readable medium may include, but is not limited to, floppy diskettes, optical disks, CD-ROMs, magneto-optical disks, ROMs, RAMs, EPROMs, EEPROMs, magnetic or optical cards, flash memory, or other type of media suitable for storing electronic instructions. Moreover, parts of the invention may also be downloaded as a computer program product, wherein the program may be transferred from a remote computer to a requesting computer by way of data signals embodied in a carrier wave or other propagation media via a communication link (e.g., a modem or network connection). In this regard, the article of manufacture may well comprise such a carrier wave or other propagation media.

The methods and apparatus are described above in their most basic forms but modifications could be made without departing from the basic scope of the invention. It will be apparent to persons having ordinary skill in the art that many further modifications and adaptations can be made. The particular embodiments are not provided to limit the invention but to illustrate it. The scope of the invention is not to be determined by the specific examples provided above but only by the claims below.

What is claimed is:

1. A method, comprising:
dividing a data table into parts;
distributing data entries in the table arranged in an order to provide periodic empty data entry spaces in each part; and
redistributing data entries in only a part of the table in which an amount of data entries in the part is changed in order to maintain the order of the table without redistributing all the data entries in the table.

2. The method of claim 1, wherein changing the amount of data entries includes one of inserting and deleting a data entry.

3. The method of claim 1, wherein the order is a logical ascending and/or descending order of the entries and a logical origin is assigned to the logically first entry in each part to find the entries in each part regardless of the position of one or more empty spaces in each part.

4. The method of claim 3, wherein the distributing data entries includes moving data entries between parts of the table to maintain a substantially even distribution of the data entries and a substantially even distribution of the empty data entry spaces in each of the parts of the table and reassigning the logical origin of a part to a new logically first entry in the part.

5. The method of claim 1, wherein the distributing data entries is performed substantially continuously.

6. The method of claim 5, further comprising using a balancing engine for the distributing data entries.

7. The method of claim 1, further comprising using a lookup engine to determine a part of the table having a data entry.

8. The method of claim 7, further comprising using an entry engine to send a data entry key to the lookup engine and receive from the lookup engine a number of a part of the table having the location of the data entry.

9. The method of claim 8, wherein the entry engine reads the part of the table corresponding to the number, sorts the entries in the part using one or more empty data entry spaces, and writes the sorted entries back into the part of the table.

10. A method, comprising:
building a table of data entries by arranging the data entries in an ascending order across sections of the table; and
substantially maintaining at least one empty data entry space in each section.

11. The method of claim 10, further comprising using a balancing engine to perform the method.

12. The method of claim 10, further comprising rearranging only a section of the table to maintain the ascending order after inserting or deleting an entry.

13. A method, comprising:
reading a section of a table of data entries arranged in an order that includes periodic empty data entry spaces;
sorting the data entries in the section to insert or delete a data entry; and
writing the section having the sorted data entries into the table.

14. The method of claim 13, wherein the order is a logically ascending order.

15. The method of claim 14, further comprising using an entry engine to perform the method.

16. An apparatus, comprising:
a memory controller coupled to a memory; and
a balancing engine coupled to the memory controller to distribute data entries across sections of a data table including substantially maintaining at least one empty data entry space in each section.

17. The apparatus of claim 16, the balancing engine further comprising:
a dynamic section size allocator to select a size for the sections of the table;
a section count monitor to monitor the number of the sections in the table;
a key entry count monitor to monitor the number of key entries in each section;
a key entry count comparator to compare the number of key entries in one section with the number of entries in at least one other section;
a scan pattern controller to control a pattern for performing the distributing of the key entries across the sections of the table; and
a key entry rippler to move the key entries within a section and/or between the sections.

18. The apparatus of claim 16, further comprising:
a lookup engine coupled to the memory controller to determine a section number of the table containing a given key entry; and
an entry engine to receive the section number from the lookup engine and insert, delete, and/or alter key entries in a section of the table corresponding to the section number.

19. The apparatus of claim 18, the lookup engine further comprising a means for finding a key entry in the table.

20. The apparatus of claim 18, the entry engine further comprising:
a section reader to read a section of the table from memory based on the section number from the lookup engine;
a key entry inserter/deleter to insert and/or delete an entry from the section;
a key entry sorter to sort key entries in the section after a key entry is inserted or deleted; and
a section writer to write the section back into the table in memory.

21. An article of manufacture, comprising:
a machine-readable medium containing content that, when executed, cause an accessing machine to:
distribute data entries in a table arranged in an order to provide periodic empty data entry spaces; and
redistribute data entries in a part of the table in which a data entry was changed to maintain the order without redistributing all the data entries in the table.

22. The article of manufacture of claim 21, wherein the instructions cause the machine to implement an ascending and/or descending ordering of the entries.

23. The article of manufacture of claim 21, wherein a data entry change includes adding and/or deleting a data entry.

24. The article of manufacture of claim 21, wherein the instructions cause a machine to distribute data entries by moving data entries between sections of the table to maintain a substantially even distribution of the data entries and a substantially even distribution of the empty data entry spaces in each of the sections of the table.

25. The article of manufacture of claim 21, wherein the instructions cause a machine to distribute data entries substantially continuously.

26. The article of manufacture of claim 28, further comprising instructions for implementing a balancing engine for the distributing data entries to maintain empty spaces in sections of the table.

27. The article of manufacture of claim 21, further comprising instructions for implementing a lookup engine to determine a section of the table having a location for a data entry.

28. The article of manufacture of claim 27, further comprising instructions for causing the machine to implement an entry engine that reads the section of the table corresponding to the section number, sorts the entries in the section using one or more empty data entry spaces, and writes the sorted entries back into the section of the table corresponding to the section number.
